(19) United States
(12) Patent Application Publication
(10) Pub. No.: US 2024/0246465 A1
(43) Pub. Date: Jul. 25, 2024

(54) SEAT CUSHION CLIP

(71) Applicant: NIFCO AMERICA CORP., Canal Winchester, OH (US)

(72) Inventor: William Russell RHOADES, Columbus, OH (US)

(21) Appl. No.: 18/413,669

(22) Filed: Jan. 16, 2024

Related U.S. Application Data
(60) Provisional application No. 63/439,920, filed on Jan. 19, 2023.

(51) Int. Cl. B60N 2/58

(52) U.S. Cl. CPC B60N 2/5825

(57) ABSTRACT

A seat clip for a seat cover anchor of a seat cover includes a base to be attached to a seat cushion; and an anchor portion attached on an upper surface of the base. The anchor portion includes a pair of extension arms extending upwardly from the upper surface of the base and disposed to face each other with a space therebetween, each extension arm having an upper end away from the base; a pair of anchor hooks formed at the respective upper ends of the pair of extension arms to extend inwardly from the upper ends of the extension arms so that the pair of anchor hooks anchor therebetween the seat cover anchor of the seat cover; and a pair of support arms formed at the respective upper ends of the pair of extension arms to extend outwardly from the extension arms at an angle towards the base.

### FIELD OF THE INVENTION

The present invention relates to a seat cushion clip, and a ganged seat cushion clips which are integrally molded into a foam of a seat cushion of a vehicle seat assembly.

### BACKGROUND OF THE INVENTION

In manufacturing a seat cushion of a vehicle, roller crushing is performed on the seat cushion after a molding process with the seat clips in their assembled positions. Specifically, the size of air bubbles inside the seat cushion is regulated by rolling a roller over the seat cushion while pressing the seat cushion. In case the seat clip is disposed inside the seat cushion, it is conceivable that the seat clips may be squashed and damaged by the roller.

On the other hand, the seat clips are individually installed into a seat cushion mold prior to the mold being filled with a foam. Namely, the seat clips are aligned in the mold, and the mold is filled during the installation process. Handling the seat clips are cumbersome as it is difficult to hold a large number of seat clips on one hand while trying to align and press the seat clips into the mold on the other hand while trying to keep up with a steady moving assembly line.

Also, in assembling the seat cushion, due to the squashing force acting on a seat cover anchor from the roller, either one of support arms formed on leading ends of extension arms of the seat clip makes contact with a base when the extension arms undergo elastic deformation, such that the anchor hooks move away from each other. The extension arms are thereby suppressed from being excessively deformed, so that the seal clip may be broken or damaged.

In consideration of the above circumstances, an object of the invention is to provide a seat clip which suppress excessive deformation to the seat clip during roller crushing of the seat cushion.

Another object of the invention is to provide a clip set connecting the seat clips or a set of pre-assembled seat clips for an installer that can be easily managed while it can be separated from the seat clip set to press the seat clips into the cushion mold.

Further object and advantages of the invention will be apparent from the following description of the invention.

### SUMMARY OF THE INVENTION

In a first aspect of the invention, a seat clip for a seat cover anchor of a seat cover comprises a base configured to be attached to a seat cushion, and an anchor portion attached on an upper surface of the base. The anchor portion includes a pair of extension arms extending upwardly from the upper surface of the base and disposed to face each other with a space therebetween, each extension arm having an upper end away from the base; a pair of anchor hooks formed at the respective upper ends of the pair of extension arms to extend inwardly from the upper ends of the extension arms so that the pair of anchor hooks is configured to anchor therebetween the seat cover anchor of the seat cover; and a pair of support arms formed at the respective upper ends of the pair of extension arms to extend outwardly from the extension arms at an angle towards the base.

Preferably, each of the support arms has a leading end so that a gap is formed between the leading end and the base allowing the support arm to make contact with the base in an event that the extension arms undergo elastic deformation and move away from each other.

Since the pair of support arms is formed outside the extension arms with the gap relative to the base, when the seat cover anchor is installed, the extension arms are bent and contact the base. Namely, since the extension arms are not excessively bent, the extension arms are not crashed or broken.

In the invention, the anchor portion further includes support ribs, each being arranged between each of the support arm and each of the extension arm to support the support arm. In this structure, even if the support arm is pushed outwardly, the support arm is not broken.

In the invention, the base includes ports configured to be attached to a seat cushion. The base can be securely fixed to the seat cushion.

In the invention, two anchor clips are arranged on the base to be spaced apart from each other so that the extension arms in one pair is aligned in a longitudinal direction with the extension arms in another pair. The base has a notch on either side of a center of the base between the two anchor portions to allow ends of the seat clip to flex in opposite directions.

In a second aspect of the invention, a clip set comprises a plurality of the seat clips, each having two anchor clips, arranged parallel to each other and connected together at side portions thereof. The plurality of seat clips has a plurality of bridge portions provided between adjacent clips.

In the second aspect, the clip set can be manufactured easily in a mold. Also, the clip set can be handled easily.

### BRIEF DESCRIPTION OF THE DRAWINGS

FIG. 1 shows an isometric view of a seat assembly of the invention.

FIG. 2 shows an exploded isometric view of an upper seat assembly.

FIG. 3 shows an exploded isometric view of a lower assembly.

FIG. 4 shows an isometric view of a seat clip.

FIG. 5 shows a top view of the seat clip

FIG. 6 shows an end view of the seat clip.

FIG. 7 shows a cross sectional front view of a lower seat cushion with the seat clip.

FIG. 8 shows a cross sectional front view of the lower seat cushion when a roller crushing is applied.

FIG. 9 shows a cross sectional front view of the lower seat when a seat cover is assembled with the lower seat.

FIG. 10 shows a cross sectional front view of the lower seat when the seat cover is assembled with the lower seat.

FIG. 11 shows a cross sectional front view of the lower seat when the seat cover is assembled with the lower seat.

FIG. 12 shows a cross sectional front view of the lower seat when the seat cover is assembled with the lower seat.

FIG. 13 shows an isometric view of ganged seat clips.

FIG. 14 shows a top view of the ganged seat clips.

FIG. 15 shows a side view of the ganged seat clips.

### DETAILED DESCRIPTION OF THE INVENTION

The present invention will be explained with reference to the accompanying drawings.

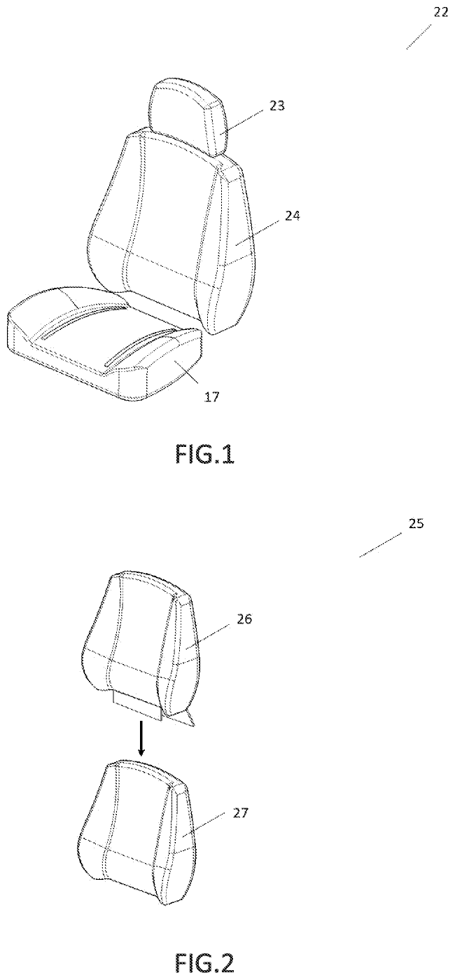

FIG. 1 shows a seat assembly 22 that includes a lower seat assembly 17, an upper seat assembly 24, and a headrest assembly 23, that respectively support the buttocks, the back and lumbar region, and the head of an occupant. FIG. 2 shows that the upper seat assembly 24 includes an upper seat cushion 27 and an upper seat cover 26.

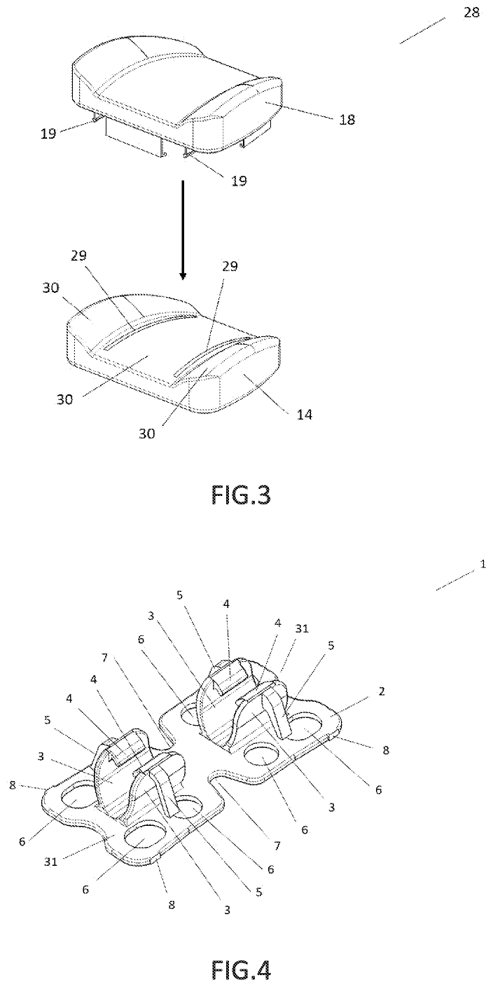

FIG. 3 shows the lower seat assembly 28 that includes a lower seat cushion 14 and a lower seat cover 18. The lower seat cover 18 has seat cover anchors 19 extending down from the bottom of the lower seat cover 18. The lower seat cushion 14 has grooves 29 that are formed between respective support foams 30. Specifically, when foam-molding the lower seat cushion 14, the seat clips 1 are inserted in the mold to dispose the seat clips 1 at the bottom of the grooves 29.

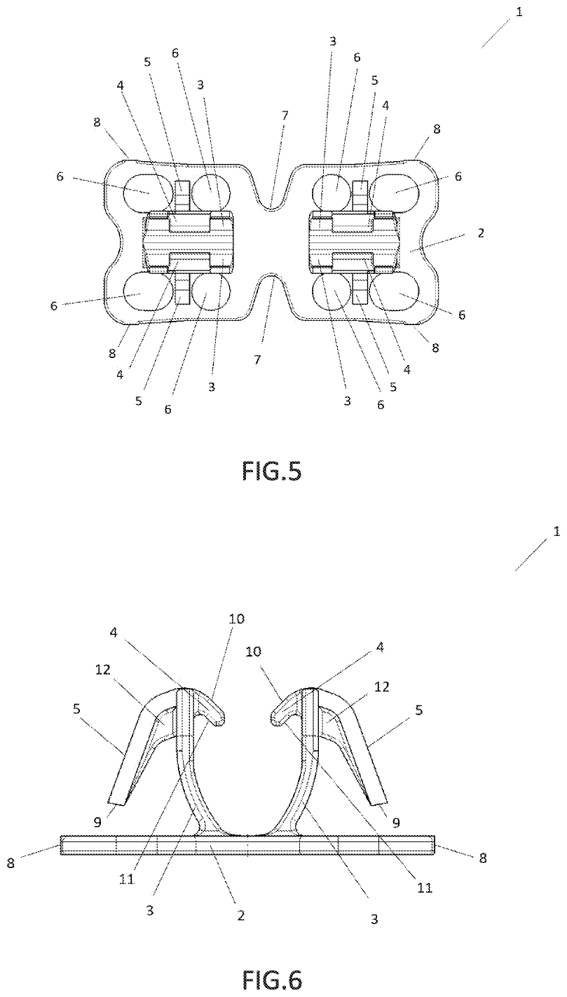

FIGS. 4-7 show the seat clip 1 that is integrally formed from a resin material, and includes abase 2, and two anchor portions 31 standing from the front face of the base section 2. The base 2 is formed by a rectangular body with four foam ports 6 in a line along both edges extending in the front-rear direction. Furthermore, the base 2 includes a pair of flex notches 7 that is centrally located to allow the base 2 to flex in different direction from one another.

The two anchor portions 31 are disposed side-by-side in the front-rear direction, standing from the front face of the base 2. One anchor portion 31 is disposed on either side of the flex notches 7 in the center of the base 2. Since each of the anchor portions 31 has a similar shape, one anchor portion 31 is explained.

Each anchor portion 31 includes a pair of extension arms 3 standing from the front face of the base 2 and disposed to face each other, and a pair of anchor hooks 4 each being formed to have a leading end at the extension arms 3. The pair of extension arms 3 and the pair of anchor hooks 4 are symmetrical to each other about a center of the base section 2 extending in the up-down direction.

The pair of extension arms 3 is angled toward the width direction outwardly to be further apart from each other at the leading end than at the base end thereof. The respective extension arms 3 are curved to protrude toward the width direction outwardly. The respective extension arms 3 are capable of undergoing elastic deformation such that the leading ends of the respective extension arms 3 move away from each other.

Furthermore, the anchor hooks 4 are formed from the leading ends of the respective extension arms 3 such that leading edges of the pair of anchor hooks 4 approach each other.

In this configuration, in a state where the seat clips 1 are disposed in the lower seat cushion 14, the anchor portions 31 are disposed in the grooves 29 of the lower seat cushions 14 and are exposed from the foam to the exterior.

To fit the pair of anchor hooks 4 around the seat cover anchor 19, the respective extension arms 3 elastically deform such that the pair of anchor hooks 4 moves away from each other. Support arms 5 are respectively formed to the leading ends of the pair of extension arms 3. The support arms 5 protrude toward the opposite sides to the side at which the extension arms 3 face each other (opposite side to the side formed with the anchor hooks 4), and each support arm 5 is formed to extrude downward at some angle towards the base 2 leaving a gap between the lower surface 9 of the support arm 5 and the top surface of the base 2.

Furthermore, a rib 12 is located between the extension arm 3 and the support arm 5 to strengthen the support arm 5 when the extension arm 3 elastically deforms. Namely, when the pair of anchor hooks 4 moves away from each other, the lower surface 9 of the support aim 5 can contact the top surface of the base 2 as to make face-to-face contact.

The seat clip 1 thus formed is molded and integrated with the lower seat cushion 4.

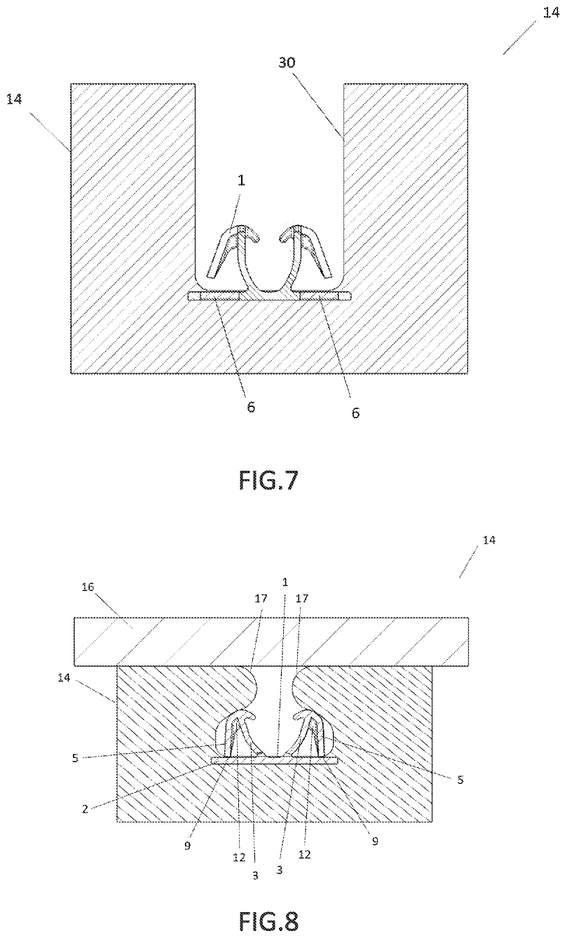

In molding the seat clip 1 into the lower seat cushion 14, the seat clip 1 is attached to a bottom of a groove forming portion where the groove 30 is formed, and the groove forming portion is placed in a main mold for forming the lower sear cushion 14. Then, a resin material for the lower seat cushion 14 is injected such that the seat clip 1 is located in a bottom of the groove 30, as shown in FIG. 7. When the lower seat cushion 14 is molded, the molding material enters the foam ports 6 of the base 2 to fix the seat clip 1 in the lower seat cushion 14.

On the other hand, the lower seat cushion 14 with the groove 30 may be formed, and then, the seat clip 1 may be glued to the bottom of the groove 30 of the lower seat cushion 14. Any method can be used for attaching the seat clip 1 to the lower seat cushion 14.

After the seat clip 1 is placed in the lower seat cushion 14, roller crushing is performed on the lower seat cushion 14.

When the roller crushing is performed following formation of the lower seat cushion 14, as illustrated in FIG. 8, a roller 16 is rolled over the lower seat cushion 14 while pressing the surfaces of the lower seat cushion 14. Air bubbles contained in the lower seat cushion 14 are thereby regulated.

At this time, the lower seat cushion 14 is pressed by the roller 16 pressing the surfaces of the lower seat cushion 14, and the pressing force from the roller 16 is transmitted to the anchor portions 31 from the up-down direction upper side.

Specifically, a pressing force pressing the extension arms 3 toward the lower side acts through the anchor hooks 4 and the support arms 5. As mentioned above, the pair of extension arms 3 is angled toward the width direction outwardly to be further apart from each other at the leading end than at the base end. The respective extension arms 3 thereby undergo elastic deformation such that the leading ends of the extension arms 3 move away from each other. The lower surface 9 of the support arms 5 makes face-to-face contact with the top faces of the base 2. The elastic deformation of the extension arms 3 is thereby limited, such that the extension arms 3 are suppressed from being excessively deformed.

When the pressing force from the roller 16 on the seat clip 1 is released, as illustrated in FIG. 7, the extension arms 3 undergo elastic recovery.

As explained above, when the roller crushing is performed following the formation of the lower seat cushions 14, the extension arms 3 undergo elastic deformation such that the pair of anchor hooks 4 moves away from each other and the support arms 5 make contact with the top surface of the base 2. The extension arms 3 are suppressed from being excessively deformed. This thereby enables damage to the seat clip 1 when performing roller crushing to be suppressed.

Next, an operation to attach the seat cover anchor 19, which is fixed to the seat cover 18, to the seat clip 1 in the lower seat cushion 14 is explained.

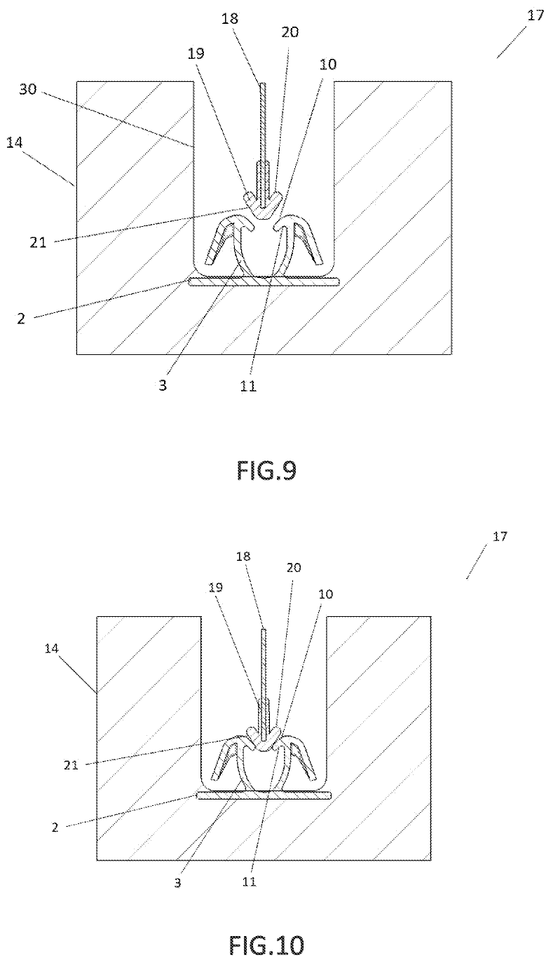

When attaching the seat cover anchor 19 to the seat clips 1, as illustrated in FIG. 9 thru FIG. 12, the seat cover anchor 18 is inserted into groove 30 in the lower seat cushion 14. When the seat cover anchor 19 is inserted into the groove 30, the tapered anchor surfaces 21 of the seat cover anchor 19 contact the hook surfaces 10 of anchor hooks 4 of the respective seat clips 1.

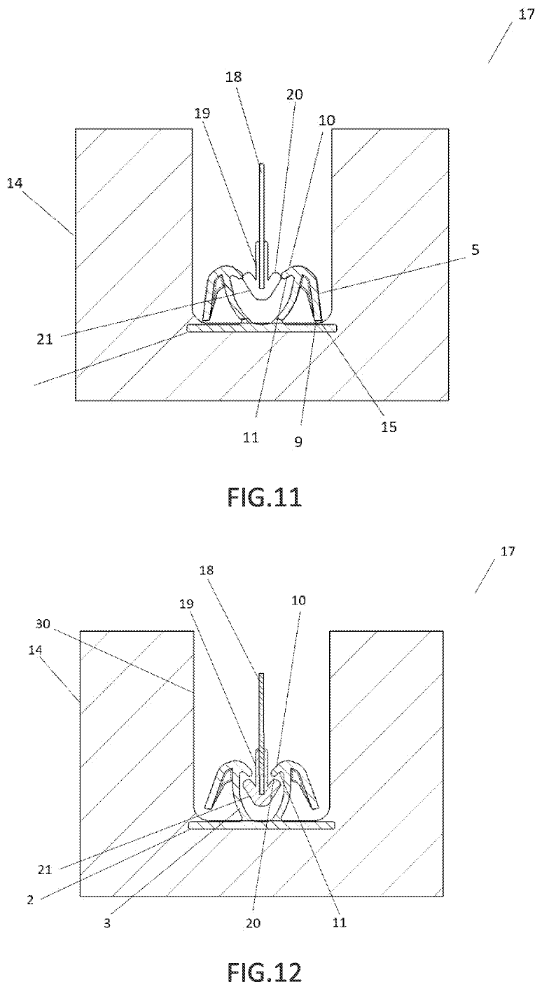

When the seat cover anchor 19 is inserted further toward the bottom of the groove 30, as illustrated in FIG. 10 and FIG. 11, the pairs of anchor hooks 4 is pressed by the seat cover anchor 19 and the extension arms 3 elastically deform such that the pairs of anchor hooks 4 moves away from each other. The seat cover anchor 19 is thereby allowed to pass between the pairs of anchor hooks 4.

When this occurs, the lower surfaces 9 of the support arms 5 and the top faces of the base 2 are not in contact, and the gap 15 is formed between each lower surface 9 and top face of the base 2. When the anchor hook 20 of the seat cover anchor 19 passes between the pairs of anchor hooks 4, as illustrated in FIG. 12, the extension arms 3 undergo elastic recovery, such that the pairs of anchor hooks 4 fits around and anchor hook 20. The seat cover anchor 19 is thereby attached to the seat clip 1. The attachment operation to attach the seat cover anchor 19 to the seat clip 1 is thereby completed.

In this operation, when the support arms 5 are bent toward the top surface of the base 2, the gaps 15 are formed between the lower surface 9 and the top face of the base 2 in a state in which the respective extension arms 2 have undergone elastic deformation. Also, the pair of extension arms 3 is angled toward the width direction outwardly so as to be further apart from each other at the leading end than at the base end. This enables the extension arms 3 to undergo elastic deformation such that the pair of anchor hooks moves away from each other when pressing force pressing toward the lower side is transmitted to the extension arms 3.

Thus, the cover anchor 19 can be inserted between the pair of anchor hooks 4 without damaging the anchor hooks 4. An efficiency of the attachment operation of the seat cover anchor 19 to the seat clips 1 can thereby be affected.

Next, a ganged clip set 120 is explained.

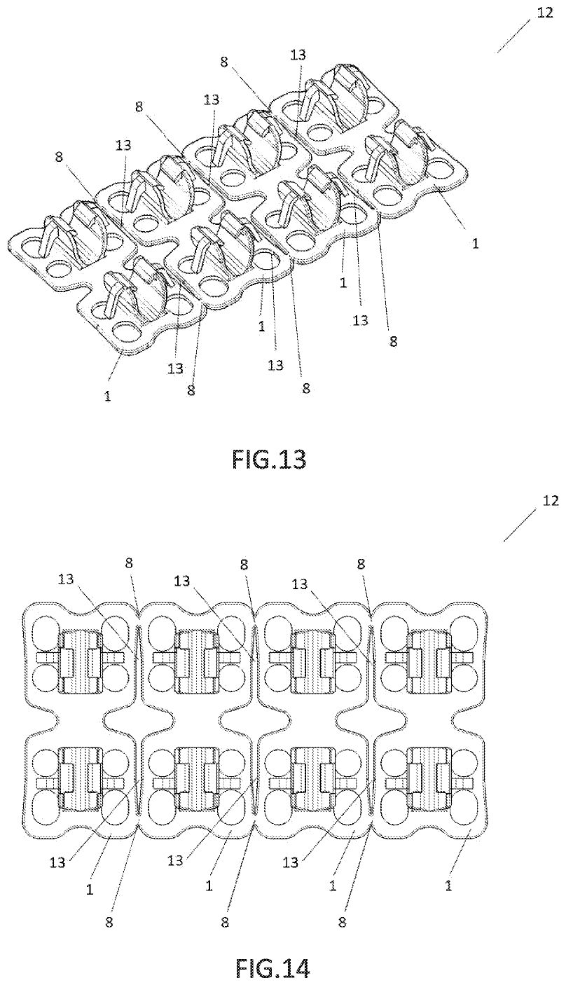

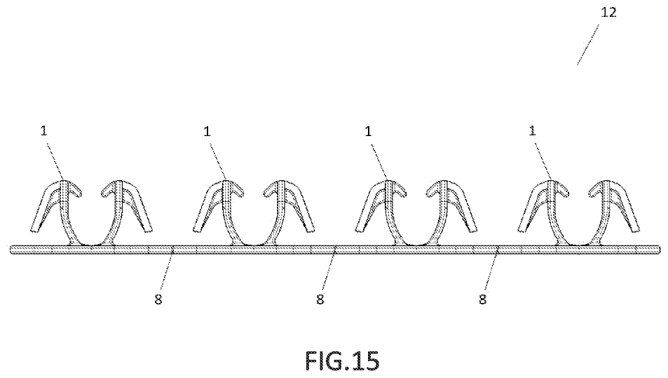

As shown in FIGS. 13-15, the ganged clip set 120 includes a plurality of seat clips 1, and is one-time molded by resin molding or the like when manufacturing the seat clips 1, though the seat clip 1 is used singly in the seat.

As illustrated in the figures, the plurality of seat clips 1 is coupled together by bridge portions 8 that connect the corners of the base 2 to form the ganged clip set 12. These bridging portions 8 form a gap 13 between the coupled seat clips 1 allowing easy separation when removing a single seat clip 1 from the ganged seat clip set 12.

In the figures, in order to shorten an overall length of the ganged clip set 12, the seat clips 1 oriented in the elongated or vertical direction are arranged in the lateral direction.

Namely, the bridge portions 8 connecting the seat clips 1 are formed on the corners of the long edges of the base 2, but the bridge portions 8 may be formed on the short edges of the base 2 instead.

According to this embodiment, when taking off the seat clips 1 from the ganged clip set 12 to install in the lower seat cushion 14, the seat clips 1 can be removed or separated by an operator with one hand by simply breaking the bridge portions 8, thereby making it possible to improve the operating efficiency as well as shorten the operating time. Furthermore, since the conventional devices, such as clamp feeding devices, are not required, the cost can be reduced. In addition, since the bridge portion 8 is a structure that can be simply broken and thus no extra member are required, the molding materials can be saved, and the removed seat clips can also be mounted in the seat without any further handling after the removal.

While only selected embodiments have been chosen to illustrate the present invention, it will be apparent to those skilled in the art from this disclosure that various changes and modifications can be made herein departing from the scope of the invention as defined in the appending claims. For example, the size, shape, location, or orientation of the various components can be changed as needed.

The foregoing descriptions of the embodiments according to the present invention are provided for illustration only, and not for the purpose of limiting as defined by the appended claims and their equivalents.

What is claimed is:

1. A seat clip for a seat cover anchor of a seat cover, comprising:
a base configured to be attached to a seat cushion; and
an anchor portion attached on an upper surface of the base, and including;
a pair of extension arms extending upwardly from the upper surface of the base and disposed to face each other with a space therebetween, each extension arm having an upper end away from the base,
a pair of anchor hooks formed at the respective upper ends of the pair of extension aims to extend inwardly from the upper ends of the extension arms so that the pair of anchor hooks is configured to anchor therebetween the seat cover anchor of the seat cover, and
a pair of support arms formed at the respective upper ends of the pair of extension arms to extend outwardly from the extension arms at an angle towards the base.

2. The seat clip according to claim 1, wherein each of the support arms has a leading end so that a gap is formed between the leading end and the base allowing the support arm to make contact with the base in an event that the extension arms undergo elastic deformation and move away from each other.

3. The seat clip according to claim 1, wherein the anchor portion further includes support ribs, each being arranged between each of the support arm and each of the extension arm to support the support arm.

4. The seat clip according to claim 1, wherein the base includes ports configured to be attached to a seat cushion.

5. The seat clip according to claim 1, wherein two anchor clips are arranged on the base to be spaced apart from each other so that the extension arms in one pair is aligned in a longitudinal direction with the extension arms in another pair, the base having a notch on either side of a center of the base between the two anchor portions to allow ends of the seat clip to flex in opposite directions.

6. A seat clip set comprising:
a plurality of the seat clips according to claim 5, arranged parallel to each other and connected together at side portions thereof, the plurality of seat clips having a plurality of bridge portions provided between adjacent clips.
